(19) United States
(12) Patent Application Publication
(10) Pub. No.: US 2026/0175339 A1
(43) Pub. Date: Jun. 25, 2026

(54) VERTICALLY MOVABLE TOOL MAGAZINE SYSTEM

(71) Applicants: HAO-CHUNG LEE, Taichung City (TW); CHEN SOUND INDUSTRIAL CO., LTD., Taichung City (TW)

(72) Inventors: HAO-CHUNG LEE, Taichung City (TW); HO-HSUN TSAI, Taichung City (TW)

(21) Appl. No.: 19/422,970

(22) Filed: Dec. 17, 2025

(30) Foreign Application Priority Data
Dec. 20, 2024 (TW) 113149790

(51) Int. Cl. B23Q 3/155; B23Q 3/157

(52) U.S. Cl. CPC B23Q 3/15506; B23Q 3/15539; B23Q 3/15706; B23Q 2003/15537

(57) ABSTRACT

A vertically movable tool magazine system is disposed on a machine tool and includes a vertically movable tool storage device and a tool changing device. The vertically movable tool storage device has a vertical movement unit movable along the Y-axis. The vertical movement unit is provided with multiple tool holder seats for tool storage. The tool changing device is movable along at least one of the X-axis and the Z-axis, and move the tool holder seat from the tool holder seat changing position to the tool changing position, allowing the spindle to replace the tool, achieving an efficient tool changing operation and reducing space of the machine tool occupied by the tool magazine. Also, a tool holder seat rotation driving unit is disposed on the tool changing device, so as to drive the tool holder seat to rotate about the Z-axis, achieving a multi-directional tool changing function.

### BACKGROUND OF THE DISCLOSURE

### 1. Field of the Disclosure

The present disclosure relates to magazine systems of machine tools, and more particularly, to a vertically movable tool magazine system.

### 2. Description of the Related Art

In order to improve machining efficiency, a machine tool is equipped with a tool magazine, such as a carousel-type tool magazine, chain-type tool magazine, or disc-type tool magazine, which is used together with a tool arm to enhance operational efficiency.

However, through practical experience by relevant technical personnel, it is known that conventional tool magazines have following technical issues.

The conventional tool magazines are unable to perform multi-directional tool changing operation. Commercially available tool magazines generally perform tool changing operation in a single direction. For example, when the spindle holds a side head, the multi-directional tool changing operation is unachievable within the same tool magazine, or a complex structure is required for changing the operational direction.

The conventional tool magazines have a small tool magazine capacity and only accommodate a single-specification tool shank. Commercially available tool magazines are capable of storing only a limited number of tools, and a single tool magazine is unable to accommodate tools with different shank specifications. For example, when the taper hole specification of the tool shank held by the side head differs from the taper hole specification of the spindle, the versatility is limited.

The conventional tool magazines have a space-occupying issue. Structures of commercially available tool magazines are complex, making it difficult to effectively reduce the tool magazine volume and consequently increasing the overall volume of the machine tool.

Accordingly, technical personnel in the field of the present disclosure are actively developing a technical solution to address the aforementioned issues, so as to improve the deficiencies of the prior arts.

### SUMMARY OF THE DISCLOSURE

The present disclosure aims at improving the issues of low tool-changing efficiency of machine tool magazines, the large installation space required by conventional tool magazines, the inability to perform multi-directional tool changing operations, and the incompatibility of taper specifications of mixed tool-holder taper specifications. Accordingly, a vertically movable tool magazine system is provided to simplify the operations required for exchanging the tool holder seats, thereby reducing the time needed for tool changing operations and improving both the tool-changing efficiency and the versatility of the tool magazine.

For achieving the aforementioned objectives, the present disclosure provides a vertically movable tool magazine system disposed on a machine tool having a worktable and at least one spindle, the vertically movable tool magazine system comprising:
a vertically movable tool storage device comprising a vertical movement unit movable along a Y-axis, the vertical movement unit having a plurality of tool holder seats arranged from top to bottom thereof, each of the tool holder seats having at least one tool, each of the tool holder seats being switchable between a plurality of tool storage positions and a tool holder seat changing position by being lifted and lowered through the vertical movement unit; and
a tool changing device configured to release the tool holder seat located at the tool holder seat changing position and drive the tool holder seat to be moved from the tool holder seat changing position to a tool changing position along at least one of an X-axis and a Z-axis, thereby allowing the spindle to remove or return the tool from or to the tool holder seat, or to return the tool holder seat to the vertical movement unit at the tool holder seat changing position along at least one of the X-axis and the Z-axis, thereby allowing the tool holder seat to resume moving between the plurality of tool storage positions along a Y-axis, so as to perform a tool changing operation.

In an embodiment of the present disclosure, the plurality of tool holder seats are disposed on the vertical movement unit through a positioning frame. The positioning frame has a plurality of support arms symmetrically arranged on the left side and right side thereof, and the plurality of tool holder seats are disposed on the corresponding support arms, respectively.

In an embodiment of the present disclosure, the vertical movement unit comprises two sliding mechanisms, a vertical movement plate, and a driving unit. The sliding mechanisms are disposed on the rear side of the machine tool, respectively. The positioning frame is fixed on the vertical movement plate. The vertical movement plate is connected to the sliding mechanisms. The driving unit drives the vertical movement plate to move along the Y-axis on the sliding mechanisms.

In an embodiment of the present disclosure, each of the sliding mechanism comprises a slide rail and a slide seat. The slide rails are fixed to the rear side of two sides of the machine tool, respectively. The slide seats are slidably disposed on the corresponding slide rails.

In an embodiment of the present disclosure, the machine tool comprises a machine base on which the worktable is disposed. The machine base has a column. The spindle is disposed on the column and movable along the Y-axis.

In an embodiment of the present disclosure, a frame body is disposed on an inner wall of the column of the machine tool. The tool changing device has an X-axis driving unit, which is disposed on the frame body and drives one of the tool holder seats to move along the X-axis.

In an embodiment of the present disclosure, the tool changing device further comprises a tool holder seat rotation driving unit. When the spindle requires tool changing in different directions (for example, when the spindle holds a side-head or when both vertical and horizontal spindles exist on the machine tool), the tool holder seat rotation driving unit of the tool changing device is able to rotate the tool holder seat about the Z-axis, thereby performing a multi-direction tool changing operation.

In an embodiment of the present disclosure, the tool changing device comprises a locking unit. Two ends of each tool holder seat have a locking hole, respectively, and the locking unit is inserted and passes through the locking hole of the corresponding tool holder seat.

In an embodiment of the present disclosure, when the spindle of the machine tool is only movable along the Y-axis, the X-axis driving unit of the tool changing device is allowed to have a Z-axis driving unit additionally disposed thereon, so as to drive one of the tool holder seats to move along both the X-axis and the Z-axis, thereby completing the tool changing operation of the spindle.

In an embodiment of the present disclosure, the tool changing device is disposed on two sides of the worktable, and the worktable is movable along the X-axis or along both the X-axis and the Z-axis.

With such a configuration, the vertically movable tool magazine system of the present disclosure achieves more efficient tool management operation through the cooperative operation of the vertically movable tool storage device and the tool changing device. The vertical movement unit is capable of performing a linear reciprocating movement along the Y-axis to be rapidly positioned for selecting the required tool holder seat, thereby significantly reducing the time required for tool holder seat changing operation. Also, the vertically movable tool storage device is arranged on the rear side of the spindle, which reduces the space occupied on the machine. The plurality of tool holder seats of the vertically movable tool storage device is able to simultaneously store multiple sets of tools, and capable of being equipped with tool holders, tool shanks, spindle heads, or side heads having identical or different specifications as needed, thereby meeting the requirements of multi-tool machining applications. Further, the tool holder seat rotation unit of the tool changing device satisfies the requirements of multi-direction tool changing operations.

### BRIEF DESCRIPTION OF THE DRAWINGS

FIG. 1 is a perspective view of the vertically movable tool magazine system in accordance with an embodiment of the present disclosure applied to a machine tool.

FIG. 2 is an side view of the vertically movable tool magazine system in accordance with an embodiment of the present disclosure applied to a machine tool.

FIG. 3 is a schematic view illustrating the vertically movable tool storage device combined with the tool changing device in accordance with an embodiment of the present disclosure.

FIG. 4 is a schematic view illustrating the vertically movable tool storage device combined with the positioning frame and the tool holder seats in accordance with an embodiment of the present disclosure.

FIG. 5 is a schematic view of the tool holder seat and the tool changing device in accordance with an embodiment of the present disclosure.

FIG. 6 is a schematic view illustrating the tool holder seat combined with the tool changing device in accordance with an embodiment of the present disclosure.

FIG. 7 is a schematic view illustrating the tool changing device driving the tool holder seat to move toward the spindle for the spindle to remove the tool in accordance with an embodiment of the present disclosure.

FIG. 8 is a side view of the tool changing device in accordance with another embodiment of the present disclosure.

FIG. 9 is a schematic view of a vertically movable horizontal tool storage device in accordance with another embodiment of the present disclosure.

FIG. 10 is a schematic view illustrating the rotation of the tool holder seat when the spindle holds a side head during a tool changing operation, so as to be aligned with the tool orientation of the spindle in accordance with an embodiment of the present disclosure.

FIG. 11 is a schematic view illustrating a Z-axis driving unit disposed on the X-axis driving unit of the tool changing device of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion. Also, the orientations of the X-, Y-, and Z-axes are as shown in the drawings.

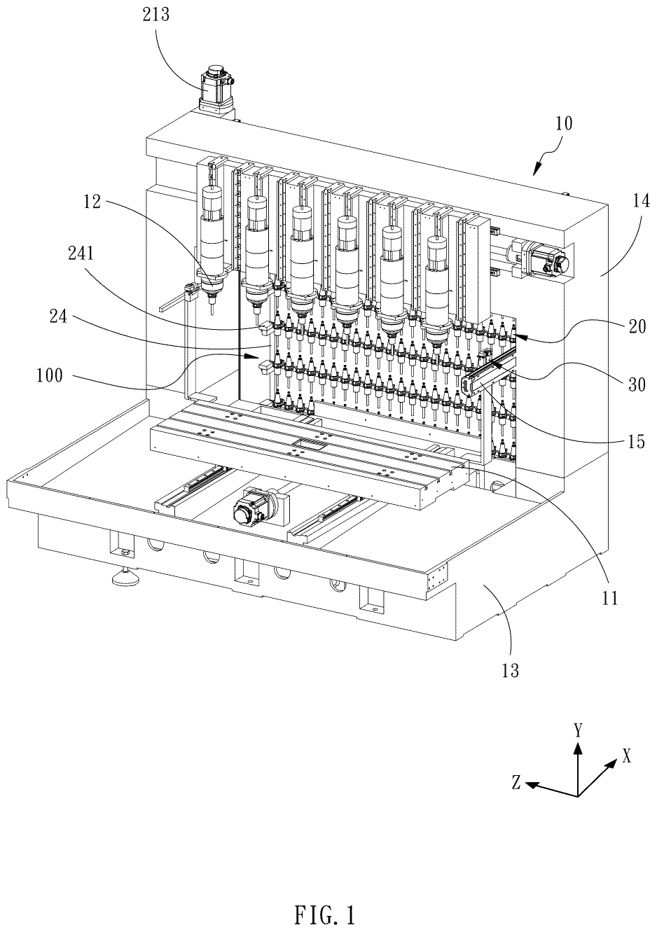

Referring to FIG. 1 to FIG. 3, the present disclosure discloses a vertically movable tool magazine system 100, which is disposed on a machine tool 10. The machine tool 10 has a worktable 11 and at least a spindle 12. The machine tool 10 has a machine base 13, on which the worktable 11 is disposed. The machine base 13 has a column 14, and the spindle 12 is disposed on the column 14 to be movable along the Y-axis. The vertically movable tool magazine system 100 comprises a vertically movable tool storage device 20 and a tool changing device 30. In the embodiment, the spindle 12 is configured to slide along the Z-axis with its axis arranged parallel to the Y-axis.

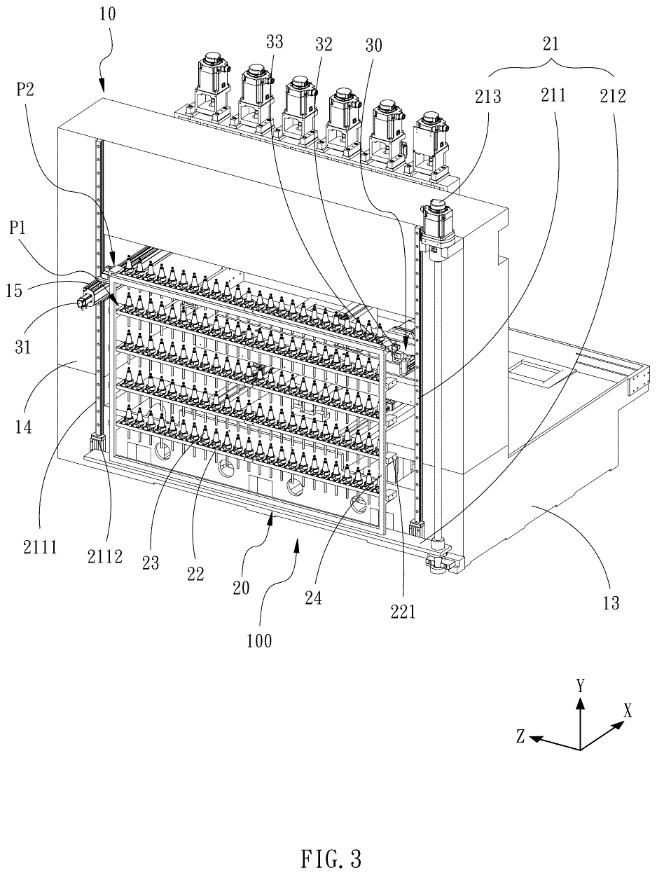

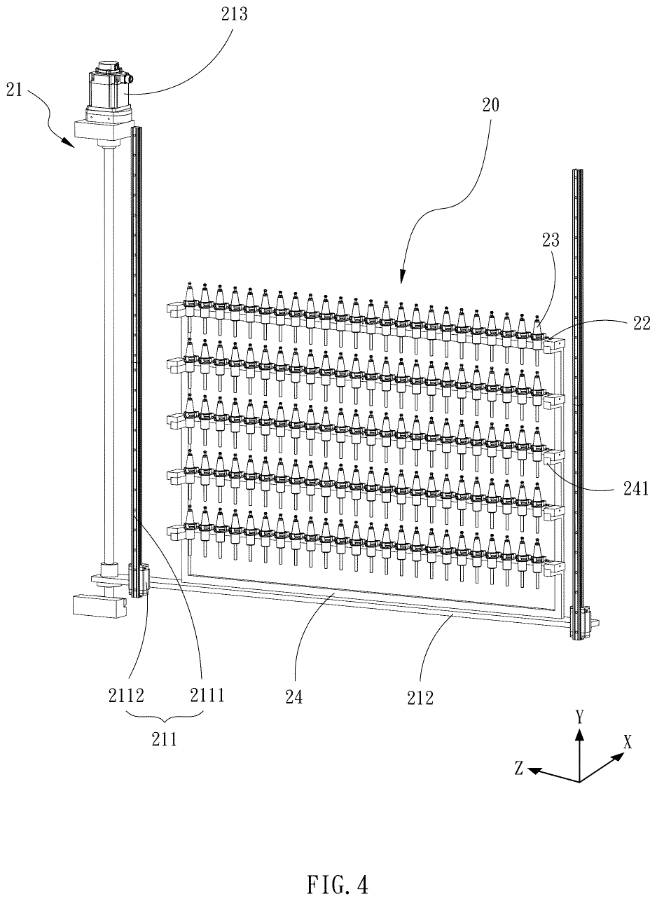

Referring to FIG. 3 and FIG. 4, the vertically movable tool storage device 20 comprises a vertical movement unit 21 configured to move along the Y-axis. The vertical movement unit 21 is provided with a plurality of tool holder seats 22 arranged from top to bottom, Each of the tool holder seats 22 has at least one tool 23. Each tool holder seat 22 is movable along the Y-axis through the vertical movement unit 21 and switchable between a plurality of tool storage positions P1 and a tool holder seat changing position P2.

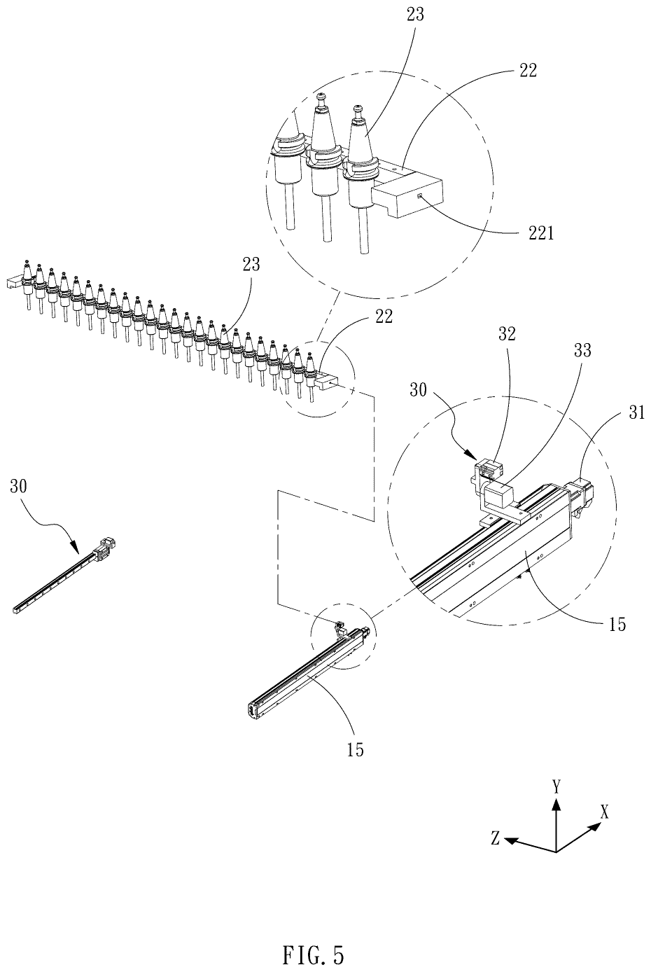

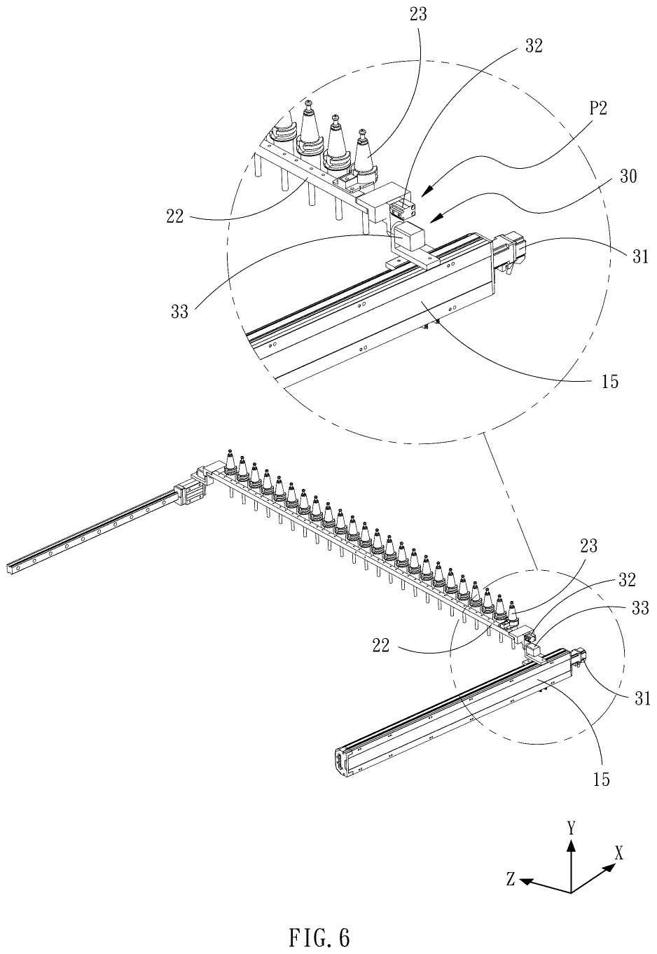

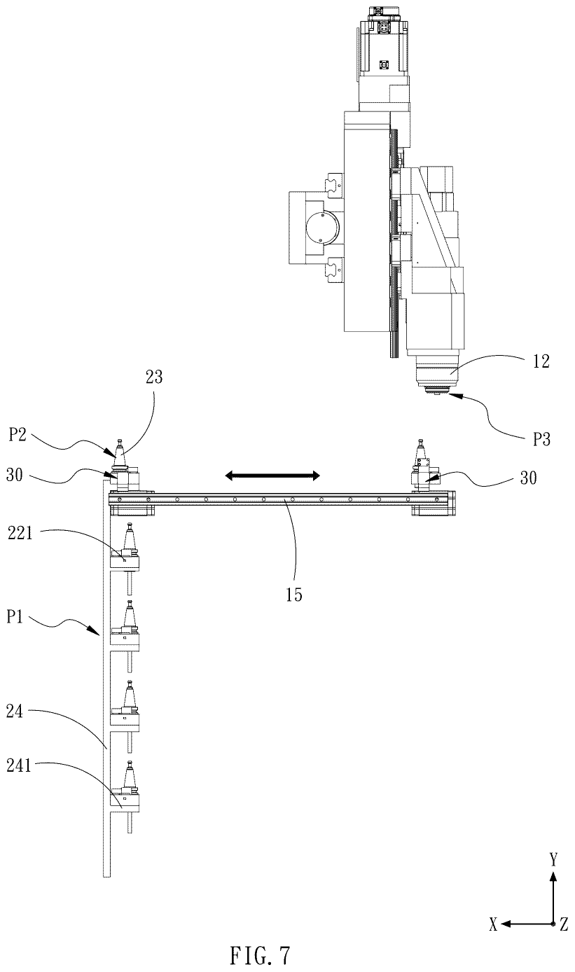

Referring to FIG. 4 to FIG. 7, the tool changing device 30 is configured to move along at least one of the X-axis and the Z-axis. In the embodiment, the tool changing device 30 moves along the X-axis and drives the corresponding tool holder seat 22 to move along the X-axis from the tool holder seat changing position P2 to a tool changing position P3, thereby allowing the spindle 12 to remove or return the tool 23 from or to the tool holder seat 22, or alternatively, to return the tool holder seat 22 to the corresponding vertical movement unit 21 at the tool holder seat changing position P2 along the X-axis (or along the Z-axis in another possible embodiment), such that the tool holder seat 22 resumes moving along the Y-axis between the plurality of tool storage positions P1.

Referring to FIG. 1 to FIG. 7, the machine tool 10 is provided with a frame body 15 disposed on the inner wall of two sides of the column 14. The tool changing device 30 comprises an X-axis driving unit 31, a tool holder seat rotation driving unit 33 configured to rotate about the Z-axis, and a locking unit 32. The X-axis driving unit 31 is disposed on the frame body 15 and configured to drive one of the tool holder seats 22 to move along the X-axis. The tool holder seat rotation driving unit 33 is configured to drive the tool holder seat 22 to rotate together with the tool 23 about the Z-axis. The locking unit 32 is configured to lock the locking holes 221 on two ends of the corresponding tool holder seat 22. With the above configuration, the tool changing device 30 enhances the efficiency of the tool holder seat 22 exchange process by rapidly and precisely moving the tool holder seat 22 to the predetermined position. The tool holder seat rotation driving unit 33 drives the tool holder seat 22 to rotate together with the tool 23 about the Z-axis in response to the tool changing direction requirements of the spindle 12. The locking unit 32 efficiently locks the locking holes 221 on both ends of the tool holder seat 22, thereby enhancing both the efficiency and stability of the exchange process.

Referring to FIG. 3 and FIG. 4, a plurality of tool holder seats 22 are disposed on the vertical movement unit 21 through a positioning frame 24. The positioning frame 24 comprises a plurality of symmetrically arranged support arms 241, wherein the plurality of tool holder seats 22 are mounted on the corresponding support arms 241, respectively. Accordingly, the positioning frame 24 and the symmetrically arranged support arms 241 provide a stable structural support, ensuring the stability of each tool holder seat 22 after being positioned.

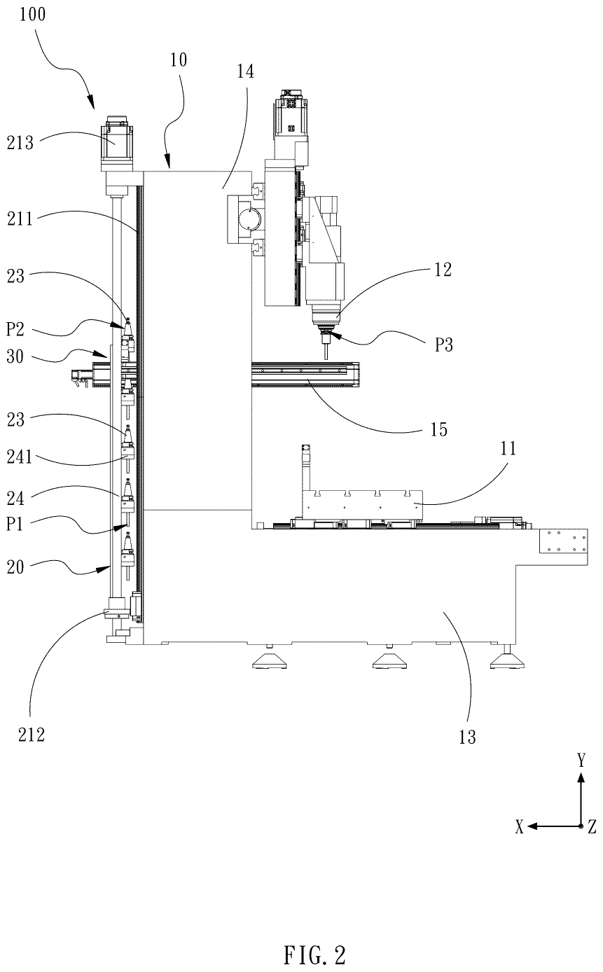

Referring to FIG. 2 to FIG. 4, the vertical movement unit 21 comprises two sliding mechanisms 211, a vertical movement plate 212, and a driving unit 213. The sliding mechanisms 211 are disposed on the rear side of the machine tool 10, respectively. The positioning frame 24 is fixed on the vertical movement plate 212, and the vertical movement plate 212 is connected to the sliding mechanisms 211. The driving unit 213 is configured to drive the vertical movement plate 212 to move vertically along the Y-axis on the sliding mechanisms 211. With such a configuration, the vertical movement unit 21 provides precise control of movement along the Y-axis, allowing the tool holder seats 22 to move more accurately between the plurality of tool storage positions P1 and the tool holder seat changing position P2.

Referring further to FIG. 2 to 4, each sliding mechanism 211 has a slide rail 2111 and a slide seat 2112. The slide rails 2111 are fixed on the rear side of two sides of the machine tool 10, respectively, and the slide seats 2112 are slidably disposed on the corresponding slide rails 2111. The slide seats 2112 are symmetrically fixed to two sides of the vertical movement plate 212. With such a configuration, the sliding mechanism 211 formed of the slide rail 2111 and slide seat 2112 ensures a smooth movement of the vertical movement unit 21 along the Y-axis.

Referring to FIG. 1 to FIG. 7, the working principle of the present disclosure is as follows.

Regarding the tool storage process, in the initial state, the tool holder seats 22 are located at the tool storage positions P1, which are distributed along the Y-axis of the vertical movement unit 21. Each tool holder seat 22 is disposed on the vertical movement unit 21.

Regarding the lifting and lowering process, when a tool holder seat 22 needs to be exchanged, the vertical movement unit 21 moves along the Y-axis, so as to move the designated tool holder seat 22 from its tool storage position P1 to the tool holder seat changing position P2.

Regarding the tool holder seat 22 removal and tool 23 exchange operation, when the tool holder seat 22 reaches the tool holder seat changing position P2, the tool changing device 30 moves along the X-axis. After locking the tool holder seat 22 at the tool holder seat changing position P2, the tool changing device 30 moves along the X-axis, such that the tool holder seat 22 is detached from the vertically movable tool storage device 20 and moves to the tool changing position P3, wherein the spindle 12 is allowed to accurately engage with the tool holder seat 22 for removing or placing the tool 23.

Regarding the returning of the tool holder seat 22, after the tool 23 in the tool holder seat 22 has been used, the tool changing device 30 moves the tool holder seat 22 along the X-axis back to the tool holder seat changing position P2 and unlocks it, after which the vertical movement unit 21 is activated again to move the tool holder seat 22 from the tool holder seat changing position P2 back to the tool storage position P1. This process ensures that the tool 23 is properly stored when not in use and prepared for the next operation.

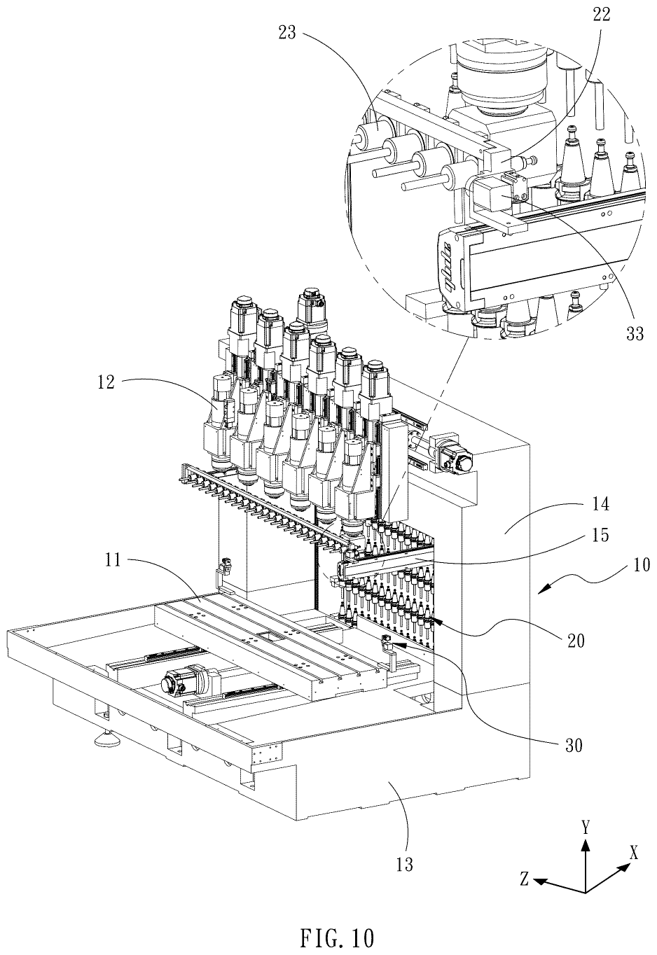

Regarding the tool holder seat 22 rotation process, referring to FIG. 10, when the tool changing direction of the spindle 12 does not match the orientation of the tool 23, the tool holder seat rotation driving unit 33 is controlled to drive the locked tool holder seat 22 about the Z-axis to be in alignment with the tool changing direction of the spindle 12.

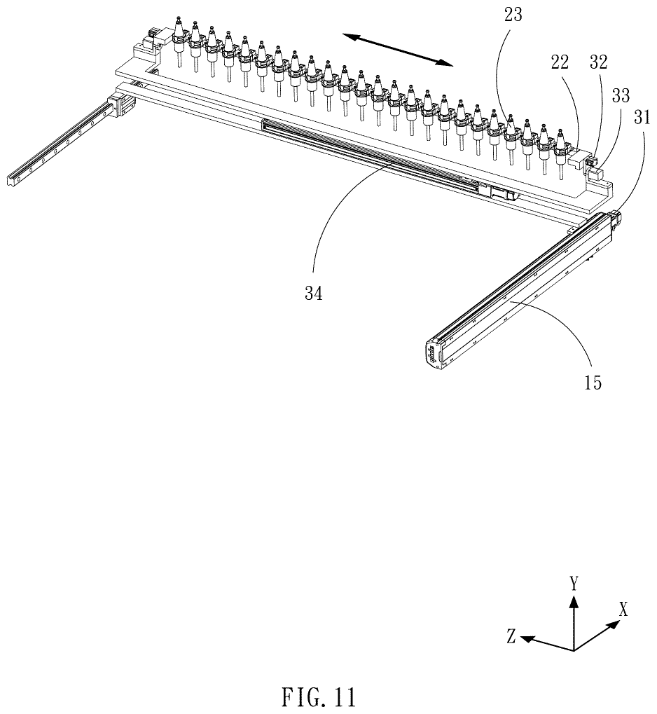

Referring to FIG. 11 in view of FIG. 2, when the spindle 12 of the machine tool 10 is only movable along the Y-axis, a Z-axis driving unit 34 is allowed to be additionally disposed on the X-axis driving unit 31 of the tool changing device 30, thereby driving one of the tool holder seats 22 to move along both the X-axis and Z-axis, so as to complete the tool changing operation of the spindle 12.

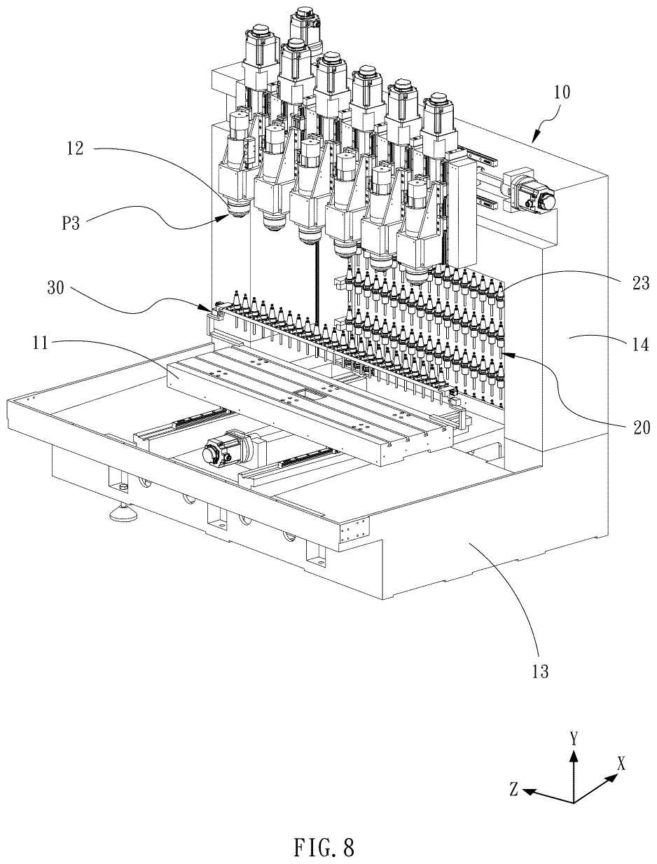

Referring to FIG. 8, the tool changing device 30 is also allowed to be disposed on two sides of the worktable 11. In addition, the tool changing device 30 is configured to be movable with the worktable 11 along the X-axis or along both the X-axis and Z-axis. With such a configuration, the tool changing device 30 reduces material costs by omitting the X-axis driving unit 31 or both the X-axis driving unit 31 and the Z-axis driving unit 34.

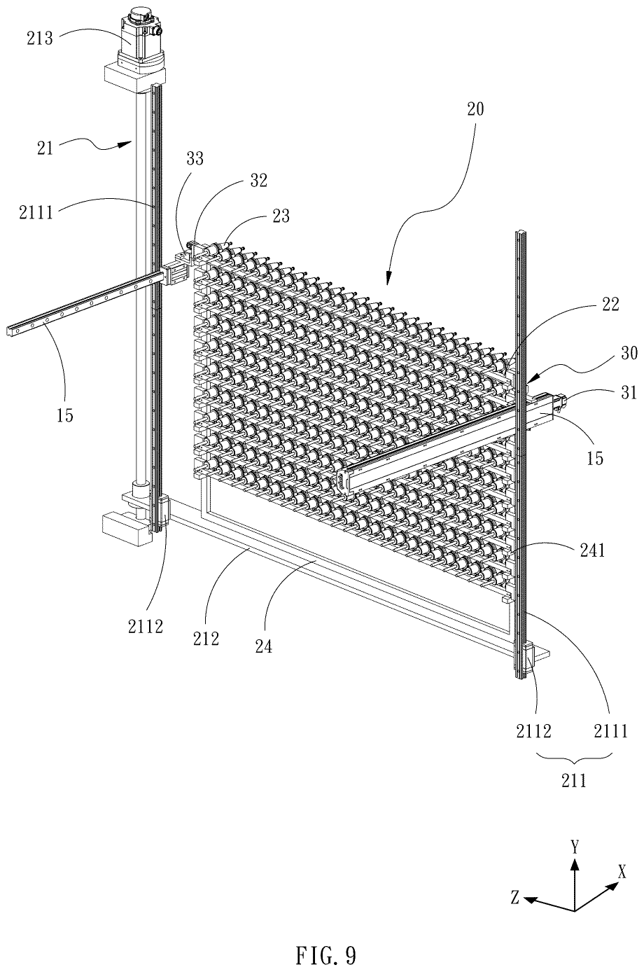

Referring to FIG. 9 in view of FIG. 3, the tool holder seats 22 and tools 23 are also allowed to be stored in a horizontal orientation, so as to increase the number of tool holder seats 22 and tools 23 or to meet the requirements of the tool changing direction.

With the foregoing configuration, the present disclosure achieves following technical features.

The present disclosure achieves a highly efficient tool 23 replacement operation. The vertically movable tool magazine system 100 of the present disclosure provides a cooperation between the vertically movable tool storage device 20 and the tool changing device 30, whereby the vertical movement unit 21 is able to rapidly position and select the needed tool holder seat 22, so as to significantly reduce the exchange time of the tool holder seat 22, thereby achieving a high-efficient replacement of the tool 23.

The present disclosure provides high space utilization efficiency. Referring to FIG. 3, FIG. 4, and FIG. 9, with the vertically movable tool storage device 20, the present disclosure arranges multiple tool holder seats 22 along the Y-axis. Such a storage arrangement effectively reduces the space required for storing the tools 23.

The present disclosure is highly versatile. With the tool holder seat rotation driving unit 33, the present disclosure enables the tool holder seat 22 to rotate according to the tool-change direction of the spindle 12, thereby achieving a multi-directional tool changing operation.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A vertically movable tool magazine system disposed on a machine tool having a worktable and at least one spindle, the vertically movable tool magazine system comprising:
a vertically movable tool storage device comprising a vertical movement unit movable along a Y-axis, the vertical movement unit having a plurality of tool holder seats arranged from top to bottom thereof, each of the tool holder seats having at least one tool, each of the tool holder seats being switchable between a plurality of tool storage positions and a tool holder seat changing position by being lifted and lowered through the vertical movement unit; and
a tool changing device configured to release the tool holder seat located at the tool holder seat changing position and drive the tool holder seat to be moved from the tool holder seat changing position to a tool changing position along at least one of an X-axis and a Z-axis, thereby allowing the spindle to remove or return the tool from or to the tool holder seat, or to return the tool holder seat to the vertical movement unit at the tool holder seat changing position along at least one of the X-axis and the Z-axis, thereby allowing the tool holder seat to resume moving between the plurality of tool storage positions along a Y-axis.

2. The vertically movable tool magazine system of claim 1, wherein the plurality of tool holder seats are disposed on the vertical movement unit through a positioning frame; the positioning frame has a plurality of support arms, and the plurality of tool holder seats are disposed on the corresponding support arms, respectively.

3. The vertically movable tool magazine system of claim 2, wherein the vertical movement unit comprises two sliding mechanisms, a vertical movement plate, and a driving unit; the sliding mechanisms are disposed on a rear side of the machine tool, respectively; the positioning frame is fixed on the vertical movement plate; the vertical movement plate is connected to the sliding mechanisms; the driving unit is configured to drive the vertical movement plate to move along the Y-axis on the sliding mechanisms.

4. The vertically movable tool magazine system of claim 3, wherein each of the sliding mechanism comprises a slide rail and a slide seat; the slide rails are respectively fixed to a rear side of two sides of the machine tool, respectively; the slide seats are slidably disposed on the corresponding slide rails, and each of the slide seats is symmetrically fixed to the vertical movement plate.

5. The vertically movable tool magazine system of claim 3, wherein the machine tool comprises a machine base on which the worktable is disposed; the machine base has a column; the spindle is disposed on the column and movable along the Y-axis; a frame body is disposed on an inner wall of the column of the machine tool; the tool changing device has an X-axis driving unit, which is disposed on the frame body and configured to drive one of the tool holder seats to move along the X-axis.

6. The vertically movable tool magazine system of claim 5, wherein the X-axis driving unit of the tool changing device has a Z-axis driving unit disposed thereon; the X-axis driving unit cooperates with the Z-axis driving unit to drive one of the tool holder seats to move along the X-axis and the Z-axis, thereby completing tool changing operation of the spindle.

7. The vertically movable tool magazine system of claim 6, wherein the tool changing device comprises a tool holder seat rotation driving unit; the tool holder seat rotation driving unit is configured to drive one of the tool holder seats to rotate, so as to align a corresponding tool shank with a tool changing direction of the spindle.

8. The vertically movable tool magazine system of claim 7, wherein the tool changing device comprises a locking unit; the locking unit is configured to lock a locking hole on two ends of the corresponding tool holder seat.

9. The vertically movable tool magazine system of claim 8, wherein the tool holder seat is configured to be equipped with tool holders, tool shanks, spindle heads, or side heads having identical or different specifications.

10. The vertically movable tool magazine system of claim 9, wherein the tool changing device is disposed on two sides of the worktable, and the worktable is movable along the X-axis or along both the X-axis and the Z-axis.
